(19) United States
(12) Patent Application Publication
(10) Pub. No.: US 2026/0104689 A1
(43) Pub. Date: Apr. 16, 2026

(54) SYSTEMS AND METHODS FOR SECURITY SCREEN PRODUCTION

(71) Applicant: Meshtec International Co., Ltd., Chiang Mai (TH)

(72) Inventors: Peter Syme Taylor, New Farm (AU); David Neil Edlin, Chiang Mai (TH)

(21) Appl. No.: 19/353,192

(22) Filed: Oct. 8, 2025

Related U.S. Application Data
(60) Provisional application No. 63/706,294, filed on Oct. 11, 2024.

(51) Int. Cl. G05B 19/18; E06B 9/52; G05B 19/401; G05B 19/4063

(52) U.S. Cl. CPC G05B 19/182; G05B 19/401; G05B 19/4063; E06B 2009/527; G05B 2219/31036

(57) ABSTRACT

There are provided systems and methods for production of security screens. Each security screen may include an infill sheet and panel assemblies engaging the infill sheet to form a panel. At least one panel assembly may include an outer sash comprising two sidewalls defining a channel therebetween, and an inner member received in the channel of the outer sash with the inner member, in turn, receiving the infill sheet. A production system may include: a cutting station using computer numerical control cutting to cut materials to form the outer sash and the inner member; a routing station receiving the cut outer sash and a profile identifying a routing style of the outer sash, the routing station using a CNC machine to form recesses in the outer sash according to the routing style; and a panel assembly station assembling the infill sheet, outer sash, and inner member to form the panel.

### CROSS-REFERENCE TO RELATED APPLICATIONS

This application claims the benefit of, and claims priority to, U.S. Application No. 63/706,294, filed Oct. 11, 2024, which is incorporated herein by reference in its entirety.

### TECHNICAL FIELD

The present application relates to security screen systems, and more particularly, to production of security screen systems.

### BACKGROUND

Security screen systems are available for various applications, including, for example, doors and windows, barrier screens, and balustrade fencing systems. These systems generally involve securing a mesh, or other infill material, within a panel by use of certain fasteners. Security screens may be used for various residential and commercial applications. In certain applications, security screens may be resistant to corrosion, allow for visibility and provide a barrier to forced entry.

The production of security screen systems involve a number of discrete steps. It would be desirable to develop approaches that may encompass and integrate together various discrete functions, such as, for example, order processing, assembly, quality control, and shipping functions. Further, it would be desirable to automate the security screen production/manufacturing process to a significant extent. There is a need for a security screen online order and shipping system and a robotic/automated production line, either separately or in combination.

### BRIEF DESCRIPTION OF DRAWINGS

FIG. 1 is a partial exploded view showing a security screen system including a security screen panel and a frame;

FIG. 2 is a schematic diagram showing a first embodiment of modules in an order placement to order completion process;

FIG. 3 is a schematic diagram showing a second embodiment of modules in an order placement to order completion process;

FIG. 4 is a schematic diagram showing a third embodiment of modules in an order placement to order completion process;

FIG. 5 is a schematic diagram showing a fourth embodiment of modules in an order placement to order completion process;

FIG. 6A is a side view of an assembled panel assembly of a security screen panel with a wedge;

FIG. 6B is a side view of the outer sash of the panel assembly of FIG. 6A;

FIG. 6C is a side view of the wedge of the panel assembly of FIG. 6A;

FIG. 7A is a side view of an assembled panel assembly of a security screen panel with a clinched portion;

FIG. 7B is a side view of the outer sash of the panel assembly of FIG. 7A;

FIG. 7C is a side view of the inner sash of the panel assembly of FIG. 7A;

FIG. 7D is a side view of the insulator of the panel assembly of FIG. 7A;

FIG. 8 is a flow diagram of a production process in accordance with some embodiments;

FIG. 9 is a flow diagram in accordance with a portion of the production process shown in FIG. 8;

FIG. 10 is a schematic diagram in accordance with a portion of the production process shown in FIG. 8;

FIG. 11 is a flow diagram in accordance with a portion of the production process shown in FIG. 8;

FIG. 12 is a schematic diagram of a production line in accordance with some embodiments;

FIG. 13 is a schematic diagram of clinching equipment and a clinching process in accordance with some embodiments;

FIG. 14 is a schematic diagram of a self-piercing riveting tool and a riveting process in accordance with some embodiments; and

FIG. 15 is a schematic diagram of a pulling machine and a pulling process in accordance with some embodiment.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

This disclosure has application to ordering and manufacturing processes for security screen systems for doors and windows of buildings, including domestic residences. For illustrative purposes, reference may be made to such applications. However, it is to be understood that this disclosure also has other applications, such as, for example, fencing and balustrade systems, insect screens for doors and windows, screens for covering openings vents, walls or partitions for structures, or any other application where a mesh screen or interface is desirable.

The following description is not to be taken in a limiting sense but is made merely for the purpose of describing the general principles of exemplary embodiments. Reference throughout this specification to “one form,” “one embodiment,” “an embodiment,” “some embodiments”, “an implementation”, “some implementations”, “some applications”, or similar language means that a particular feature, structure, or characteristic described in connection with the embodiment is included in at least one embodiment of the present disclosure. Thus, appearances of the phrases “in one embodiment,” “in an embodiment,” “in some embodiments”, “in some implementations”, and similar language throughout this specification do not all refer to the same embodiment.

The terms “top” and “bottom,” “upper” and “lower” and “vertical” and “horizontal as may be used herein are by way of example and illustrative purposes only and are not meant to limit the description of the embodiments inasmuch as the referenced item can be exchanged in position and orientation. Also, as used herein, the terms “substantially” and/or “about” mean that the specified dimension or parameter may be varied within an acceptable manufacturing tolerance for a given application.

At a high level, and without limitation, this disclosure is generally directed to comprehensive and integrated systems for order processing, assembly, quality control, and shipping of security screen systems. It is desirable to arrange the different discrete stages so that the different stages cooperate and transfer information smoothly between them. Also, at a high level, and without limitation, this disclosure is directed to an automated or semi-automated production line process for the manufacture of security screen systems.

Although the description is generally directed to the production and manufacture of security screen systems, it should be understood that this disclosure is not limited to the production and/or manufacture of any particular types of security screen systems made of any particular types of materials. Rather, the disclosure herein may be applied to the production and/or manufacture of a variety of security screen systems and other products, including, for example, other types of door, window, fencing, and balustrade systems.

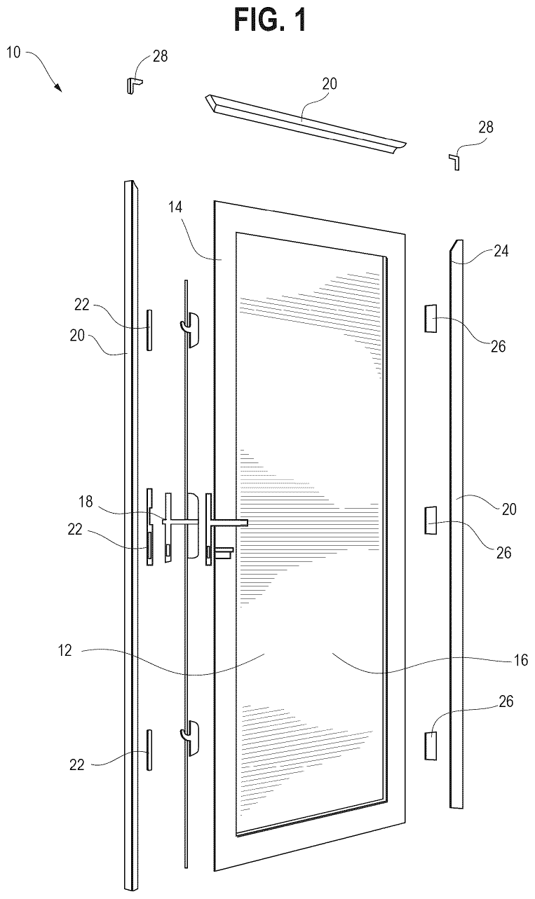

FIG. 1 shows a security screen system 10 in the form of a door, although windows and other security screen types are also available. FIG. 1 identifies some of the common elements of security screen systems. In this form, the system 10 includes a rectangular security screen panel 12 composed of multiple panel assemblies 14 (in this case, four panel assemblies). The panel assemblies 14 define an opening that is occupied by a mesh/infill screen 16. The panel assemblies 14 collectively extend about and support the mesh/infill screen 16. The material of the mesh/infill screen 16 may be any of various types of infill materials, such as, for example, stainless steel wire, a perforated metal sheet, insect resistant fabric, etc. The panel assemblies 14 are typically aluminum channels with a variety of internal structures. The edges of the mesh/infill screen 16 are fastened within the panel assemblies 14, which are in turn joined to one another at the corners. When the term “mesh” is used in this disclosure, it should be understood to also broadly refer to any infill material that might be used in a screen panel.

The security screen system 10 may also include hardware, such as latches 18, that are mounted to the security screen panel 12. Further, the security screen system 16 may include a security screen frame 20 with frame components, such as striker plates 22, seals 24, hinges 26, and corner stakes 28, that facilitate mounting of the security screen system 10 to a building frame. Some of these elements of security screen systems are addressed further below in the context of the ordering and/or production processes. Details of various embodiments of panel assemblies, mesh/infill screens, and other aspects of security screen systems are described, for example, in U.S. Pat. Nos. 6,802,357 and 8,191,606, which are incorporated by reference herein in their entirety.

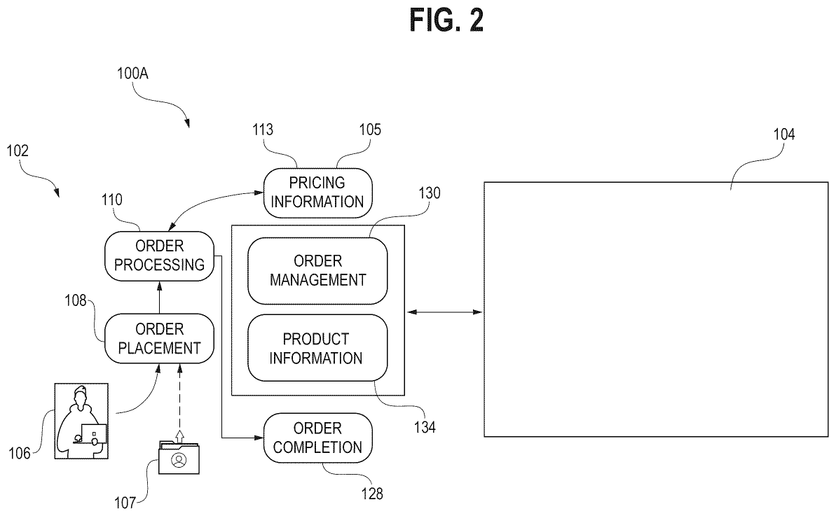

FIGS. 2-5 show several examples of a system for order placement to order completion for security screen systems. These examples show several possible implementation options for online ordering by customers. In some forms, it is generally contemplated that customers can prepare and submit their orders by either entering manually or uploading a file in an agreed format via some web application. Once the order is received, the ordering system will send confirmation back and will also preferably send periodic updates regarding the order status back to the customer's web application until the order is completed. In one form, the ordering system may include a web order application/architecture 102 (essentially, an online order system) to facilitate an order by a customer/user, an internal enterprise resource planning (ERP) system 104, and ERP software modules 105.

FIG. 2 shows a first example of an ordering system 100A directed to order taking and tracking. It is generally contemplated that a user/customer will place an order via his or her device 106. In this example, coding/software modules 105 are generally directed to order taking and tracking: order placement 108, order processing 110, pricing information 113, and order completion 128. The order processing module 110 generally accesses information from the product information module 112 before proceeding to order completion 128. In this example, the software modules 105 may be grouped into two categories: (1) order management 130 (including order placement 108, order processing 110, and order completion 128 modules); and (2) production information 134 (including a pricing information 113 module). It is generally contemplated that these categories integrate data and allow task and data flow with an internal ERP system 104 (such as, for example, a system using some form of Microsoft Dynamics 365®).

As stated, the ordering system 100A may include multiple modules 105 that involve the performance of various operations and functions. The modules 105 may generally involve computing systems with microcontroller, computer, or processor-based devices with processor, memory, and programmable input/output peripherals, which are generally designed to communicate with, and/or govern the operation, of other components and devices. The modules 105 may also include various memory devices, network interfaces, wireless networks, and cloud databases and other databases. These architectural options are well known and understood in the art and require no further description here. The modules 105 may be configured (for example, by using corresponding programming, such as computer instructions, non-transitorily stored in a memory as will be well understood by those skilled in the art) to carry out one or more of the steps, actions, and/or functions described herein. Various modules 105 may communicate with one another and exchange information.

In one form, the ordering process may include several steps involving back and forth between the customer/user and the ordering system 100A. The user's order may initially be inputted to the web order application system 102. For example, the user may login to an existing account or may create a new account to place his or her order. During order placement 108, the system may display on the user's device 106 various categories of products, such as door, window, screen, hardware aluminum, and other categories. The user may select a category, e.g., door, and the web order application system may then display various door options, and the user may select a door type. The web order application may include real time product images and information. In one form, the user may select a change to product color/dimensions etc., which is reflected in a real-time product image. In a similar manner, the user may then select screen/mesh options and frame options. The user may then add shipping and billing information and place the order.

The system 100A may automatically generate a sales order in the ERP system 104. For example, sales orders may be listed one-by-one in a spreadsheet, and each order may be clickable to access its details. The system 100A may automatically send an email notification to the user's device 106 indicating receipt of the order. It may further provide follow-up email notifications, such as indicating if an item does not exist and confirming that a sales order has been successfully created.

This option generally involves modules that manage and maintain customer order, pricing confirmation, and order status tracking. Main production control, inventory, and financial transactions are maintained separately. The data interaction between the two systems is generally customer order detail sent over to create the sales order. Both the sales order and production order status may be sent back and shown on the customer's screen when checked.

FIG. 2 shows a high level of task concepts and data flow between the web order application 102 and the ERP system 104. Data integration between these two may include order and customer management 130 and product information 134, such as, for example, with regard to product name, item code, color, size, etc. Users can submit their order by either entering manually or uploading a file 107 (which may be generated from their ERP system) in an agreed format. It is generally contemplated that the pricing information 113 may be either on the web order application side or may be on the ERP side. Once the ERP system 104 receives the order, it will send confirmation back and send updates back to the under device 106 until the order is completed.

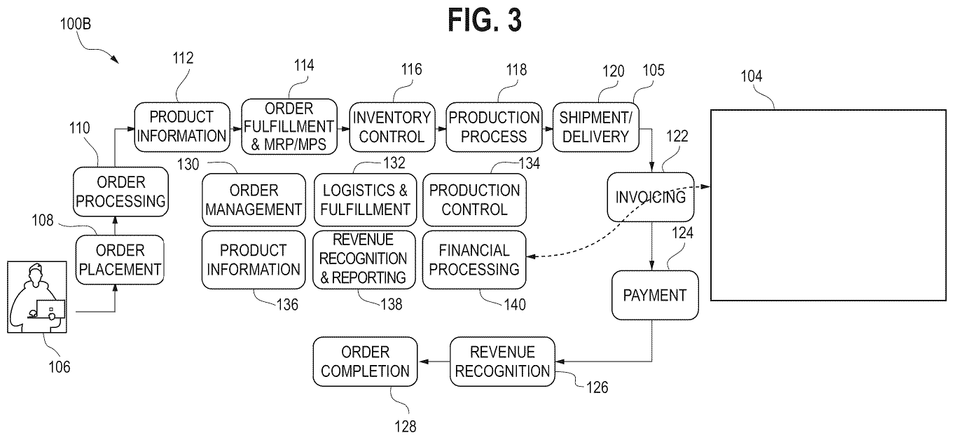

FIG. 3 shows a second example of an order placement-to-completion system 100B where more ERP modules 105 have been added. It is again generally contemplated that a user/customer will place an order via his or her device 106. In this example, there are more modules 105, and it is generally contemplated that there is more automated control over the entire process. For instance, in this second example, inputted data may be consolidated and shared so as to allow some automated control of production.

In this example, the system 100B includes a number of discrete modules 105 performing various functions and providing information to other modules 105: order placement 108, order processing 110, product information 112, order fulfillment and materials requirement planning/master production schedule (MRP/MPS) 114, inventory control 116, production process 118, shipment/delivery 120, invoicing 122, payment 124, revenue recognition 126, and order completion 128. The modules 105 are generally utilized as one proceeds in a clockwise manner in FIG. 3. Further, the modules 105 may be grouped into six categories: (1) order management 130 (including order placement 108, order processing 110, and order completion 128 modules); (2) logistics and fulfillment 132 (including order fulfillment and MPR/MPS 114, inventory control 116, and shipment/delivery 120 modules); (3) production control 134 (including production process 118 module); (4) product information 136 (including product information 112 module); (5) revenue recognition and reporting 138 (including revenue recognition 126 module); and (6) financial processing 140 (including invoicing 122 and payment 124 modules). It is generally contemplated that these six categories consolidate data and allow task and data flow with an internal ERP system 104 (such as, for example, using some form of Microsoft Dynamics 365).

This option generally involves ERP modules 105 that manage and maintain all transactions related to manufacturing and financial activities. Each module may have its own transaction that is able to trigger the related modules when particular condition(s) have been met. For example, after a customer purchase order has been confirmed, it will be converted to a sales order, which means there is a requirement to be fulfilled. MRP/MPS will check the availability of the material and production capacity to create production planning and production scheduling. A production order will then be created according to the plan. In the meantime, a request for the required raw material might be created. The production order will then pass through each production process and related inventory/financial transactions will also be created accordingly. The completed production order will then trigger the packing order and the next operation of the sales order to continue to shipment process and invoice.

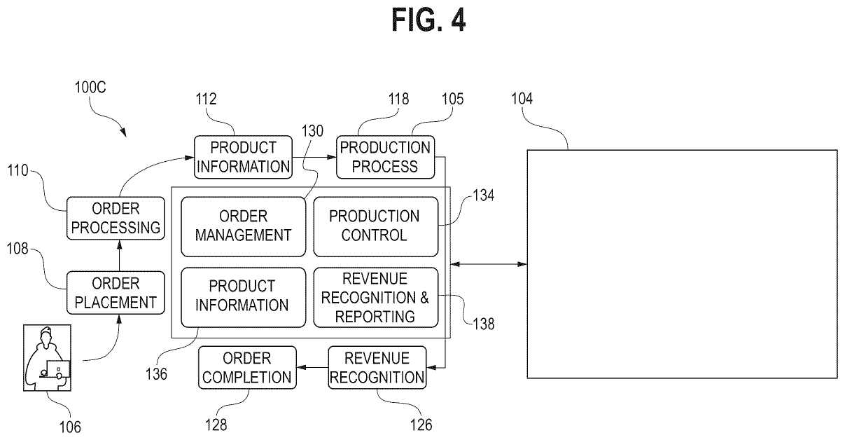

FIG. 4 shows a third example of a system 100C where only selected modules 105 have been developed, not all of the ERP modules shown in FIG. 3. It is generally contemplated that a user/customer will place an order via his or her device 106. In this example, there are fewer discrete modules 105 performing various functions and providing information to other modules 105: order placement 108, order processing 110, product information 112, production process 118, revenue recognition 126, and order completion 128. The modules 105 are generally utilized as one proceeds in a clockwise manner in FIG. 4. In this example, the modules 105 may be grouped into four categories: (1) order management 130 (including order placement 108, order processing 110, and order completion 128 modules); (2) production control 134 (including production process 118 module); (3) product information 136 (including product information 112 module); and (4) revenue recognition and reporting 138 (including revenue recognition 126 module). Other actions may be performed in conjunction with other systems. It is generally contemplated that these categories integrate data and allow task and data flow with an internal ERP system 104 (such as, for example, Microsoft Dynamics 365). This option refers to specific modules 105 that manage and maintain the customer order, pricing confirmation, production scheduling, and billing transactions.

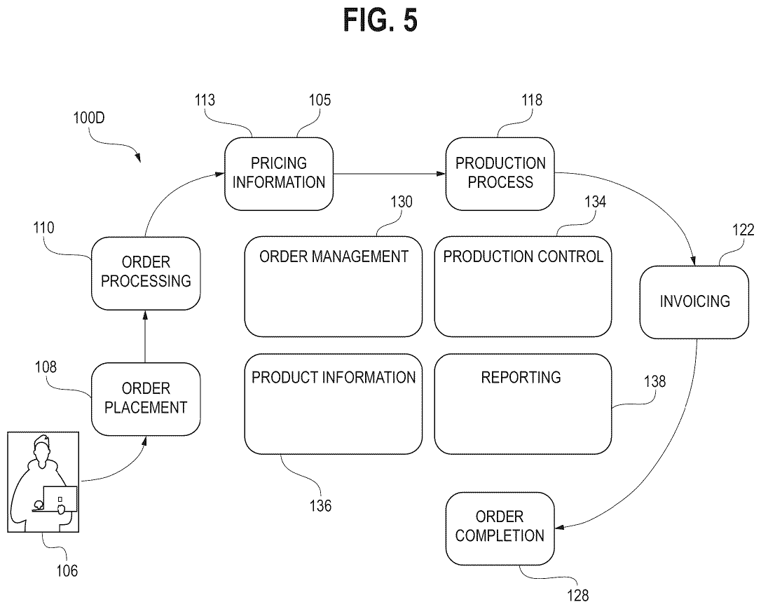

FIG. 5 shows a fourth example of a system 100D that is directed generally to an assemble-to-order package. In this option, there are modules 105, but there is no interaction with the internal ERP system 104 at all. It is generally contemplated that a user/customer will place an order via its device 106. In this example, the modules may include: order placement 108, order processing 110, pricing information 113, production process 118, invoicing 122, and order completion 128. The modules 105 are generally utilized as one proceeds in a clockwise manner in FIG. 5. Further, the modules 105 may be grouped into four categories: (1) order management 130 (including order placement 108, order processing 110, and order completion 128 modules); (2) production control 134 (including production process 118 module); (3) product information 136 (including product information 112 module); and (4) reporting 138 (including invoicing 122 module).

Another aspect of this disclosure focuses on automation or semi-automation of the manufacturing and assembly process for security screens, such as for security doors and windows. In some forms, these approaches may be a sub-part or sub-system of the order-placement-to-completion systems described above. For example, particular orders may dictate certain portions of the production process. In other forms, they may represent a stand-alone manufacturing and assembly process for security screen systems. In some forms, it is contemplated that a production area may be used to manufacture, at least, two different types of security screen panel, such as, for example, a wedged security screen panel and a clinched security screen panel.

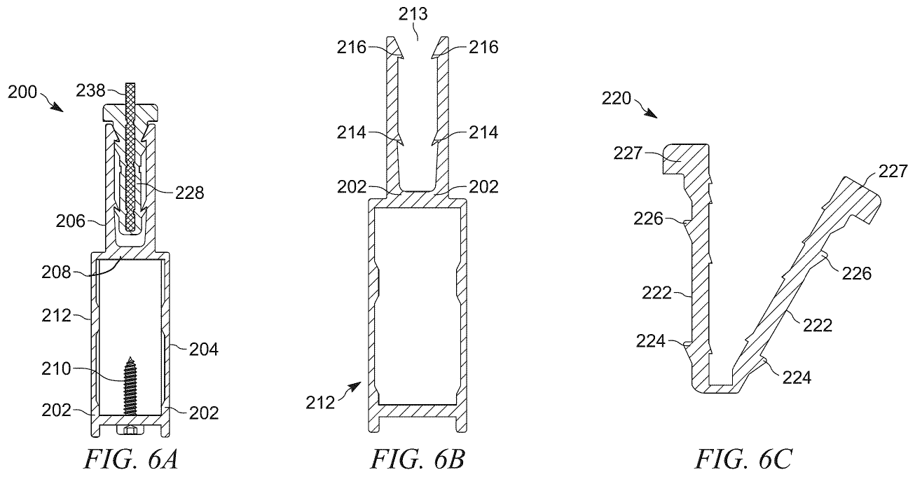

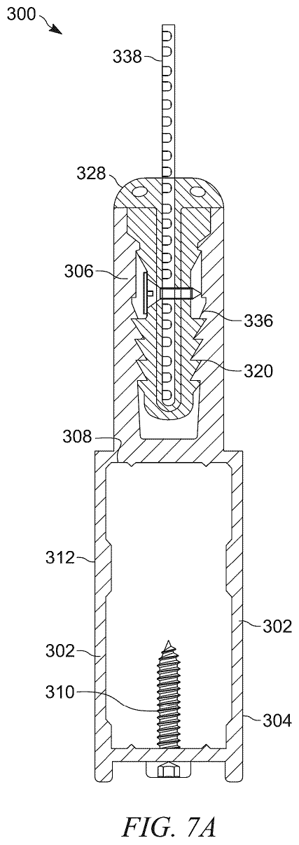

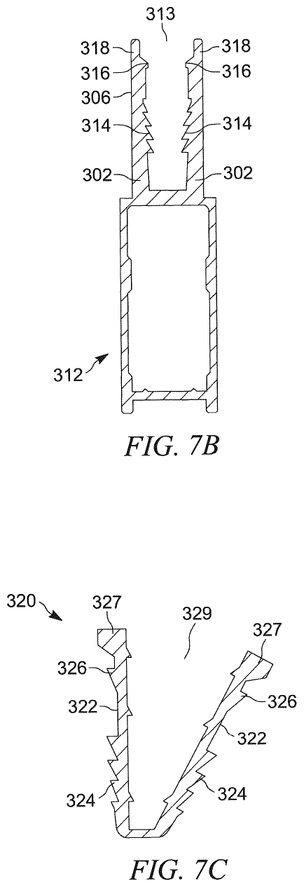

FIGS. 6A, 6B, and 6C show an example of a security screen panel that uses a wedge and that may be assembled according to a production process described below. In this security screen panel, panel assemblies are used to hold and maintain an infill sheet. An example of a security screen panel 12 with four panel assemblies 14 used to hold a mesh/infill 16 was shown in FIG. 1.

In FIGS. 6A, 6B, and 6C, in one form, each panel assembly generally includes an outer sash and a wedge/adhesive combination that receives the mesh. It is generally contemplated that the wedge/adhesive can be inserted into, and is received within, the outer sash. In other words, the mesh may be received within (and retained by) the wedge/adhesive combination, which may, in turn, be received within (and retained by) the outer sash. An example of a similar security screen panel is described in U.S. application Ser. No. 18/769,945, filed Jul. 11, 2024, which is incorporated herein by reference in its entirety.

FIG. 6A shows one example of a security screen panel assembly 200 in an assembled condition. The panel assembly 200 may include an outer sash 212 that receives the wedge (or inner member) 220 within a channel 213 of the outer sash 212 (and the wedge 220, in turn, may receive the mesh 238). As can be seen, in this form, the outer sash 212 generally includes sidewalls 202, a base portion 204, a top portion 206, and a dividing wall 208. FIG. 6B shows the outer sash 212 prior to assembly. It may include engagement features, such as hooks 214 and teeth 216, that engage and help retain the wedge 220 within its channel 213. FIG. 6C shows the wedge 220 prior to assembly. The wedge 220 may include corresponding engagement features, such as hooks 224 and teeth 226, that engage the outer sash 212. The wedge 220 may include two legs 222 with a plug (or stopper) portion 227 at an end of each leg.

In one form, a glue or adhesive may be applied between the mesh 238 and the wedge 220, and one or both of the glue/adhesive and wedge 220 may act as an insulator, either alone or in combination with one another. The adhesive strip may be applied such that it is disposed between the mesh/infill 238 and wedge 220 and helps hold them together. Each security screen panel generally includes four panel assemblies 200. Corner screws (or stakes) 210 are used at each of the corners of the panel to fasten one panel assembly 200 to another.

An example of a method of assembly is described for a security screen panel with a wedge. The mesh may be cut to a desired rectangular size, and adhesive may be applied to front and back of each of the outer four edges of the mesh. Each wedge may be applied over the front and back of each outer edge over the adhesive. Four outer sashes may be applied over the wedges along the four sides of the rectangular panel. Corner stakes in the outer sashes may be used to fasten the outer sashes to one another. The corners may be crimped to engage the corner stakes and to secure the outer sashes to one another. Although an example of a wedged system and method of assembly are provided, it should be understood that various modifications may be made.

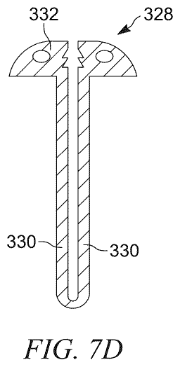

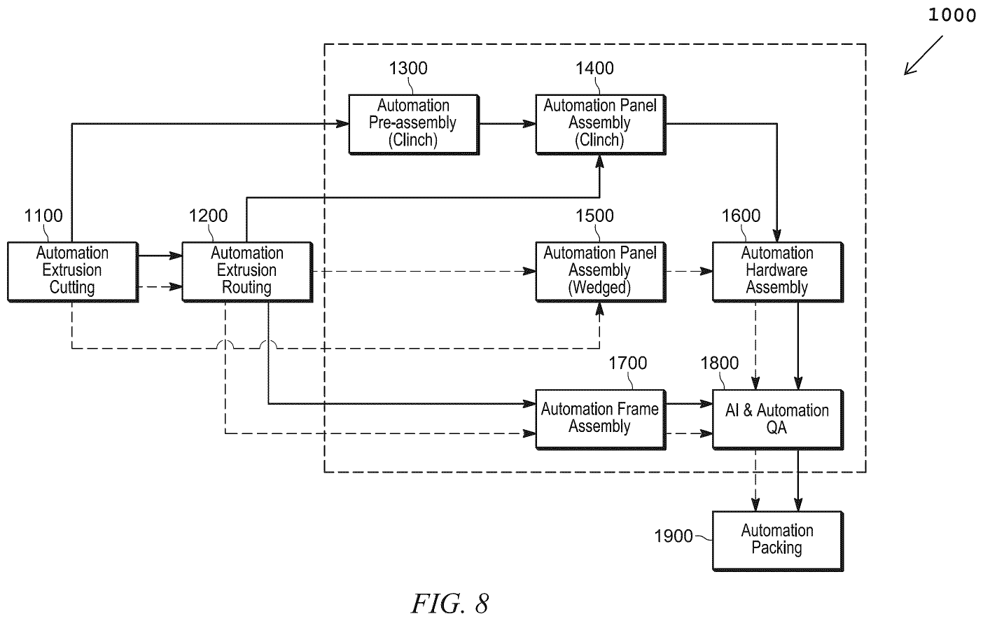

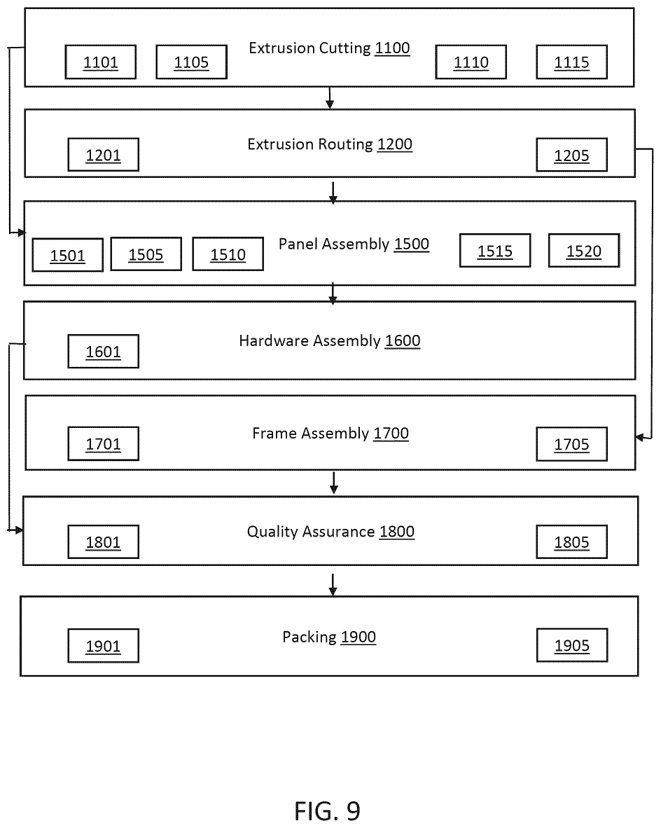

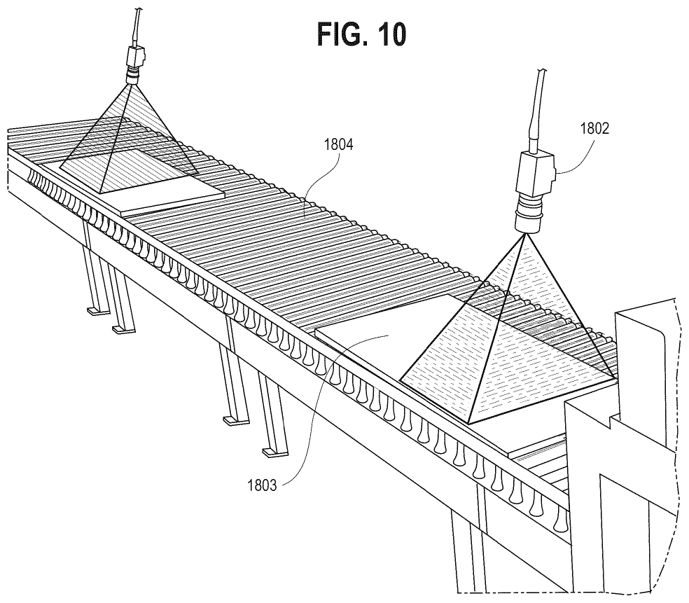

FIGS. 7A, 7B, 7C, and 7D show an example of a security screen panel that may use clinch fixing and that may be assembled according to a manufacturing process described below. In the security screen panel, panel assemblies are used to hold and maintain a mesh/infill. In this form, each panel assembly generally includes an outer sash, an inner sash (or inner member), and an insulator. The insulator receives the mesh. It is generally contemplated that the insulator (with mesh) can then be inserted into, and is received within, the inner sash, and this combination is then clinched together. This combination may then be affixed together with a fastener. The assembly may then be inserted into, and is received within, the outer sash. Examples of similar security screen panels are described in U.S. application Ser. No. 18/769,945, filed Jul. 11, 2024, which is incorporated herein by reference in its entirety.

FIG. 7A shows one example of the security screen panel 300 in an assembled condition. In this example, the panel assembly may include an outer sash 312 that receives the assembly of inner sash 320, insulator 328, and mesh 338 within a channel 313 of the outer sash 312. In one form, the outer sash 312 may include sidewalls 302, a base portion 304, a top portion 306, a dividing wall 308, walls 318, and corner fixing screws 310. FIG. 7B shows the outer sash prior to assembly. It includes engagement features, such as teeth 314 and 316, that engage and help retain the inner sash 320 within its channel 313.

FIG. 7C shows one form of an inner sash 320 prior to assembly. The inner sash 320 may include corresponding engagement features, such as teeth 324 and 326, that engage the outer sash. The inner sash 320 may include two serrated legs 322, walls 327, and a channel 329. FIG. 7D shows the insulator 328 prior to assembly. The insulator 328 may include two lip portions 330 that terminate in a cap 332. The mesh and/or other infill 338 is preferably fixed in place within the insulator 328 by a fastener 336, such as a support screw or rivet. The insulator 328 receives the mesh 338 and is, in turn, received by the inner sash 320, and this combination is fixed together with¬a fastener 336. Each security screen panel generally includes four panel assemblies. Corner screws (or stakes) are used at each of the corners of the panel to fasten one panel assembly to another.

An example of a method of assembly is now described. The mesh may be cut to a desired rectangular size, and the insulator may be applied over the front and back of each of the outer four edges of the mesh. An inner sash may be applied over the front and back of each outer edge over the insulator. The mesh, insulator, and inner sash may be clinched together. Then the combination may be affixed together with a fastener, such as by use of a self-piercing riveting (SPR) tool. Four outer sashes may be applied over the inner sashes along the four sides of the rectangular panel. Corner stakes in the outer sashes may be used to fasten the outer sashes to one another. The corners may be crimped to engage the corner stakes and to secure the outer sashes to one another. Although an example of a system and method of assembly are provided, it should be understood that various modifications may be made.

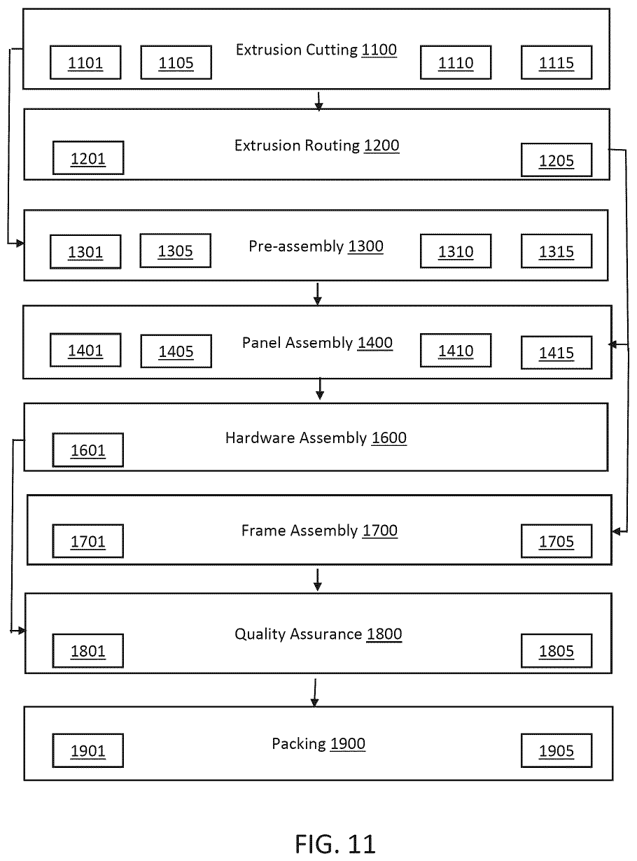

FIG. 8 shows a flow diagram for one example of a security screen manufacturing process 1000 involving both a wedged system and a clinched system. It is generally contemplated that the process 1000 involves some common (or similar) steps for both the wedged system and the clinched system and some specific steps that apply to only one or the other. The process 1000 may include steps for the wedged system shown by the dashed flow lines, and/or the process 1000 may include steps for the clinched system shown by the solid flow lines. The steps involving the wedged system and the clinched system are described as follows, and the steps that are specific to each system are identified. It should be understood that, in some embodiments, the process 1000 may not include all of the steps shown, may include additional steps not shown, and/or some steps may be combined. In some embodiments, some of the steps may be performed in a different order.

At block 1100, in one form, extrusion cutting may be performed to cut the wedge, outer sash, frame components, and corner stake to desired sizes and shapes. At block 1200, extrusion routing may be performed on certain elements (the outer sash and frame) to create recesses and hollows of various shapes in these elements, such as, for example to receive latches and handles. At block 1300 (specific to the clinched system), panel pre-assembly may be performed to clinch and then apply a fastener to the inner sash, insulator, and mesh together. At block 1400 (specific to the clinched system), panel assembly may be performed in which the panel pre-assembly is combined or integrated with the outer sash into the security screen panel. Optionally, a cover sash may be used to cover screw heads in the outer sash, and a wedged seal may be used to limit dirt and reduce noise caused by mesh vibration. At block 1500 (specific to the wedged system), panel assembly may be performed to integrate the outer sash, wedge, and mesh into the security screen panel, i.e., to bring together these panel components.

At block 1600, in one form, the hardware is assembled, such as, for example, adding handles and locks to the panels. At block 1700, frame components may be installed/inserted on the frame (such as, for example, striker plates and seals), and frame assembly and hardware assembly may be performed in parallel. It is generally contemplated that frame assemblies with corner screws (or stakes) are used at each of the corners of the frame to fasten one frame assembly to another, as shown in FIG. 1. It is also generally contemplated that the frame attaching to the screen panel may generally be separate from the screen panel until installed by the user.

At block 1800, AI driven visual inspection and quality assurance is performed, such as, for example, confirming the correct dimensions of the product. AI driven visual inspection may be used to automatically analyze and inspect door and window products using high-resolution cameras to capture images of the items being inspected and using image processing software. A main purpose of these systems is to ensure quality control and verify that items meet specified criteria. Inspection tasks may involve, for example, detecting and identifying scratches, dents, and corner joints quality; measuring dimensions and checking if they fall within acceptable ranges; and ensuring that parts are assembled correctly or that labels and markings are accurate. At block 1900, the product is packed.

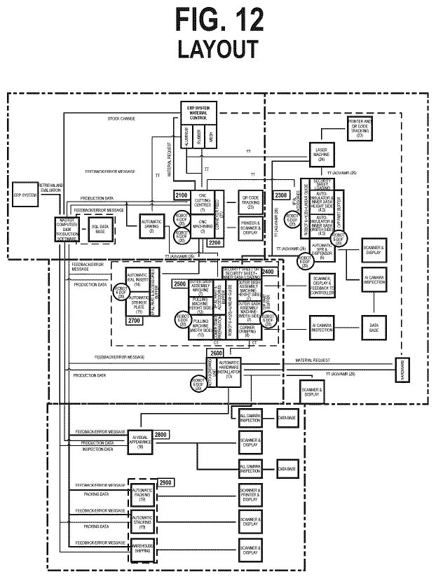

Table 1 is shown below breaking out the flow shown in FIG. 8 into sub-processes that apply generally to the wedged system. FIG. 9 generally shows the processes and sub-processes for the wedged system assembly. It should be understood that, in some embodiments, the wedged system assembly may not include all of the processes/sub-processes shown, may include additional processes/sub-processes not shown, and/or some processes/sub-processes may be combined. In some embodiments, some of the processes/sub-processes may be performed in a different order.

TABLE 1
Wedged System

| | Module/ | | | |
|---|---|---|---|---|
| Previous | Submodule | Next | Process | Sub-process |
| | 1100 | | Extrusion | |
| | | | Cutting | |
| | 1101 | | | Wedge/insulator cutting |
| | 1105 | | | Outer sash cut |
| | 1110 | | | Frame cut |
| | 1115 | | | Corner stake cut |
| | 1200 | | Extrusion | |
| | | | Routing | |
| | 1201 | | | Outer sash routing |
| | 1205 | | | Frame routing |
| | 1500 | | Panel | |
| | | | Assembly | |
| | | | (Wedged) | |
| | 1501 | | | Attach adhesive tape to |
| | | | | insulator |
| | 1505 | | | Insert insulator to outer |
| | | | | sash |
| | 1510 | | | Assemble outer sash to |
| | | | | mesh sheet |
| | 1515 | | | Crimping |
| | 1520 | | | Wedge assemble |
| | 1600 | | Hardware | |
| | | | Assembly | |
| | 1601 | | | Assemble hardware |
| | 1700 | | Frame | |
| | | | Assembly | |
| | 1701 | | | Assemble frame |
| | 1705 | | | Crimping and fastening |
| | | | | striker plate |
| | 1800 | | Quality | |
| | | | Assurance | |
| | | | (QA) | |
| | 1801 | | | Finished goods (FG) |
| | | | | panel |
| | 1805 | | | FG frame |
| | 1900 | | Packing | |
| | 1901 | | | FG panel |
| | 1905 | | | FG frame |

In one form, module 1100 is extrusion cutting that is performed at an extrusion cutting station and includes sub-processes (or sub-modules) 1101, 1105, 1110, and 1115 for cutting various components. In sub-module 1101, automated extrusion cutting of the wedge of the security screen panel may be performed. In sub-module 1105, automated extrusion cutting of the outer sash of the security screen panel may be performed. In sub-module 1110, automated extrusion cutting of the frame may be performed. In sub-module 1115, automated cutting of the corner stakes of the security screen panel may be performed. This module 1100 and sub-modules 1101, 1105, 1110, and 1115 are common to (or similar in) both the wedged and clinched security screen systems.

In one form, it is contemplated that this cutting may be automated using computer numerical control (CNC) for cutting and machining. This CNC approach allows computer control of movement and cutting of the various components and workpieces so as to allow them to be machined in a precise and consistent manner. Further, cutting may be facilitated through the use of robotic devices, conveyor feeding, and barcode or QR code tracking, as addressed further below.

At sub-module 1101, in one form, CNC cutting centers or stations are used in which a wedge/insulator is placed on the feeding unit of the machine that can support large quantities, and then the feeding unit of the machine carries the wedge/insulator through to the automatic cutting unit. The automatic cutting unit adjusts the cutting length and cuts the wedge/insulator based on the data length and shape sent from the system. The machine generates a QR code or barcode of a profile and the cutting data and automatically attaches it to the wedge/insulator. The wedge/insulator is then sent to the next station via an automatic transfer device, such as a conveyor.

At sub-module 1105, in one form, the CNC cutting process is similar to sub-module 1101, but there is a change from the wedge/insulator cutting profile to the outer sash aluminum cutting profile. At sub-module 1110, the CNC cutting is changed to the frame aluminum cutting profile. At sub-module 1115, the automatic cutting machine may be CNC-operated using a corner stake aluminum cutting profile at the machine. The machine cuts and feeds the corner stake according to the parameters sent from the system.

In one form, the flow then proceeds to module 1200, which is extrusion routing and includes sub-modules 1201 and 1205. At sub-module 1201, the outer sash may be routed. The outer sash profile is preferably transferred from the previous extrusion cutting station by an automatic transfer device (such as a conveyor) to the extrusion routing station. At the beginning of the routing process, there is preferably a scanner to read the data from a QR code or barcode attached to the workpiece. The machine program identifies the routing style of the outer sash and sends a control signal to a robot (such as, for example, a robotic arm) to pick up the outer sash and send it to the CNC machine. The CNC then routes or mills the workpiece according to the style specified by the program. When the CNC machine has finished routing or milling the outer sash, the robot preferably picks up the workpiece and places it on an automatic transfer device to be sent to the next station.

At sub-module 1205, in one form, the frame is routed. The frame may be transferred from the extrusion cutting station to the extrusion routing station by a transfer device, such as a conveyor. The automation approach is similar to sub-process 1201 (outer sash) and preferably involves a robot and CNC machine but with a change to the frame aluminum routing profile. This module 1200 and sub-modules 1201 and 1205 are common to (or similar in) both the wedged and clinched security screen systems.

In one form, the flow proceeds from extrusion cutting 1100 and extrusion routing 1200 to process (or module) 1500, which is assembly of a wedged security screen panel, such as panel assemblies shown in FIGS. 6A, 6B, and 6C. The flow skips processes 1300 and 1400, which are specific to the clinched security screen system and which are described below. Instead, the flow proceeds to process 1500, which is unique or specific to the wedged security screen system.

At process 1500, in one form, the wedged panel is assembled. At sub-process 1501, adhesive tape is attached to the wedge/insulator. An individual picks up the wedge/insulator from a cart and places it on an adhesive application machine, which applies the adhesive tape on the wedge/insulator along its length. When finished, the adhesive tape is released. At sub-process 1505, the wedge/insulator (with adhesive tape) is inserted in the outer sash. An individual picks up the outer sash from the cart and then inserts the wedge/insulator with adhesive tape into the channels of the outer sash along the length of the outer sash on all four sides of the panel.

At sub-process 1510, in one form, mesh sheets that have been cut to size have been arranged on a trolley and parked at a designated area, and then a robotic device (such as a robotic arm) picks up an individual mesh sheet and places it on a work surface that is preferably in the form of an assembly table or positioning fixture. A positioning fixture generally aligns and clamps a workpiece in a desired position and orientation. An individual may insert the corner stakes in the outer sashes and then place them into the cart and park the cart to the designated area. In one form, the robotic device picks up the outer sashes corresponding to the sides of the mesh sheet and positions them on the positioning fixture holding the mesh sheet. Elements of the fixture pushes them into engagement so as to attach them to the mesh sheet. The panel is then transferred to the next position/station.

At block 1515, in one form, the panel is centered. After that, crimping heads of a crimping machine or robotic device will move to the four corners of the panel. The machine will crimp the corners tightly and control a corner gap within a specified value. After the four corners are crimped, the panel is automatically transferred to the next position.

At block 1520, in one form, assembly of the wedged panel is completed. When the panel moves to this specified position, automatic clamp sets hold the panel in place. A robot may pick up a wedge seal from a storage cart and insert the wedge seal adjacent the outer sash on an inner perimeter of the panel. The wedge seal may be inserted into the gap between the outer sash and the mesh sheet. Also, a pulling automation head may press the wedges against the outer sashes along the four sides of the panel, thereby securing and tightening the wedges to the outer sashes. The panel is then transferred to the next station.

In one form, the flow then proceeds to process (or module) 1600 and sub-process (or module) 1601, which is assembly of the hardware. When the panel moves to the next specified position, automatic clamp sets hold the panel in place. A robot picks up a hardware lock set from a storage cart and places it into the slot of an outer sash that has been prepared to receive the hardware lock set during the routing process. The robot fastens the hardware lock to the panel with screws. The panel may be automatically transferred to the next process/station.

In one form, the flow may proceed from extrusion routing 1200 to process (or module) 1700, which is assembly of the frame. At sub-module 1701, an individual picks up a frame from a cart and places it on an insertion machine. The machine may automatically insert an absorber seal into the groove of the frame along its length and may release when finished.

In one form, at sub-module 1705, an individual may insert a corner stake into the frame and place a top frame portion, a bottom frame portion, a left frame portion, and a right frame portion on a positioning fixture. Elements of the positioning fixture may press the frame portions into engagement and may assemble the frame to achieve the required dimensions and angles. The corners are crimped tightly. A robot picks up the striker plate and places it in a specified position, and riveting equipment attached to the robot fastens the striker plate to the frame at the specified position.

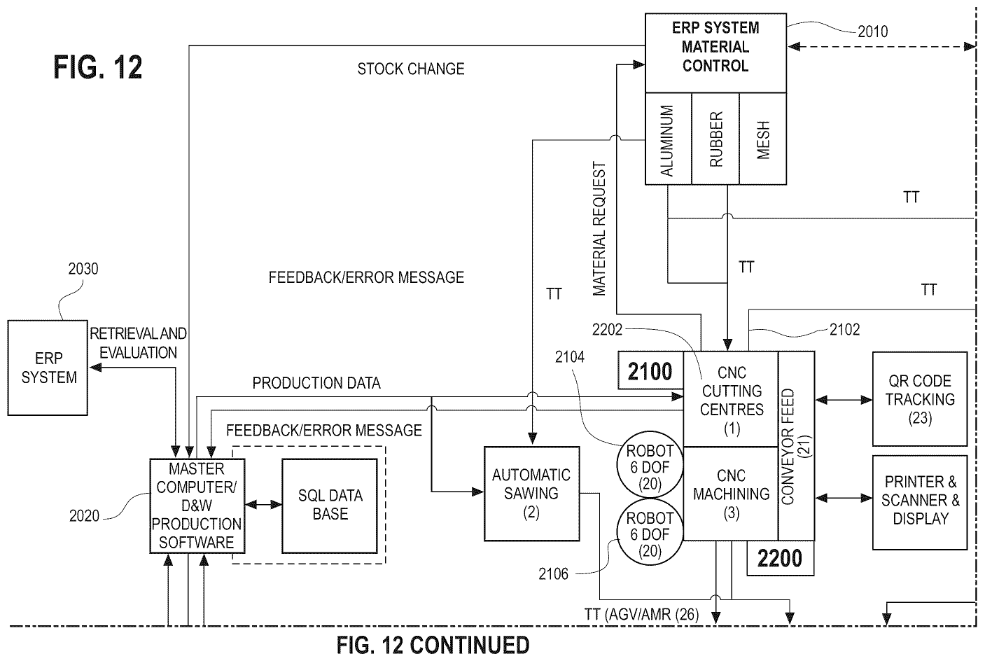

In one form, the process flow may proceed from hardware assembly 1600 and frame assembly 1700 to module 1800, which is quality assurance. At sub-module 1801, the finished goods (FG) panel, or assembled panel, may be inspected. When the panel moves to the specified position, AI camara inspection preferably analyzes and inspects the position of the locking setup, the quantity of screws, and the finished size by using data, such as labeled images, associated metadata from databases, and feedback from machine learning. FIG. 10 shows an example of a camera system 1802 inspecting a finished/assembled panel 1803 moving along conveyor 1804. In a similar manner, in one form, at sub-module 1805, the finished goods (or assembled) frame may be inspected. AI camara inspection preferably analyzes and inspects (such as by image processing) the position of the striker plate setup, the quantity of screws, and the finished size by using data, such as labeled images, associated metadata from databases, and feedback from machine learning.

In one form, the process flow then proceeds to module 1900, which is packing. At sub-module 1901, the finished goods panel may be packed. For this station, the assembled panel may be transferred through various stages of the packing process preferably by conveyor or other transfer device. The packing process may use shrink wrapping, which uses plastic film that shrinks tightly around the assembled panel when heated. Next, wraparound packaging may use cardboard to form a protective box around the assembled panel. Packing automated systems may adjust to different panel sizes and shapes. Further, labels, barcodes, or QR codes may be applied for identification and tracking. Stacking and palletizing systems may arrange packaged panels onto pallets or in stacking configurations for shipment or storage in warehouse.

In one form, at sub-module 1905, the finished goods (or assembled) frame may be packed. For this station, the assembled frame may be transferred through various stages of the packing process preferably by conveyor or other transfer device. The packing process may use shrink wrapping, which uses plastic film that shrinks tightly around the assembled frame when heated. The assembled frame may be inserted into a box with an assembled panel.

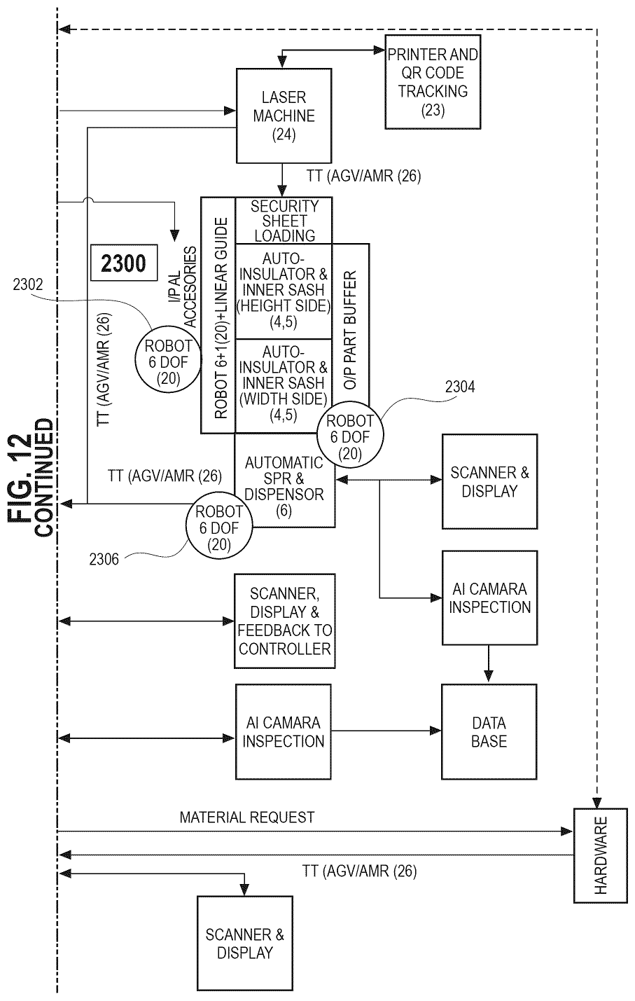

Table 2 shown below shows a table breaking out the flow shown in FIG. 8 into sub-processes that apply generally to the clinched system. FIG. 11 generally shows the processes and sub-processes for the clinched system assembly. Table 2 also shows, in one form, specific individual sub-processes (or sub-modules) that may be previous and/or next sub-modules after other specific individual sub-modules. It should be understood that, in some embodiments, the clinched system assembly may not include all of the processes/sub-processes shown, may include additional processes/sub-processes not shown, and/or some processes/sub-processes may be combined. In some embodiments, some of the processes/sub-processes may be performed in a different order.

TABLE 2
Clinched System

| | Module/ | | | |
|---|---|---|---|---|
| Previous | Submodule | Next | Process | Sub-process |
| | 1100 | | Extrusion | |
| | | | Cutting | |
| | 1101 | 1305 | | Inner sash cutting |
| | 1105 | 1201 | | Outer sash cutting |
| | 1110 | 1205 | | Frame cutting |
| | 1115 | 1401 | | Corner stake cut |
| | 1200 | | Extrusion | |
| | | | Routing | |
| 1105 | 1201 | 1401 | | Outer sash routing for |
| | | | | hardware device slot |
| 1110 | 1205 | 1701 | | Frame routing for |
| | | | | hardware device slot |
| | 1300 | | Pre-assembly | |
| | 1301 | 1305 | | Attach the insulator to |
| | | | | security sheet |
| 1101 | 1305 | 1310 | | Inner sash to mesh |
| 1305 | 1310 | 1315 | | Clinching |
| 1310 | 1315 | 1401 | | Self-pierce riveting |
| | 1400 | | Panel | |
| | | | Assembly | |
| | | | (Clinched) | |
| 1115 + | 1401 | 1405 | | Assemble outer sash to |
| 1201 + | | | | mesh |
| 1315 | | | | |
| 1401 | 1405 | 1410 | | Crimping corners |
| 1405 | 1410 | 1415 | | Pulling insulator and |
| | | | | inner sashes |
| | 1600 | | Hardware | |
| | | | Assembly | |
| 1410 | 1601 | 1801 | | Assemble hardware |
| | 1700 | | Frame | |
| | | | Assembly | |
| 1205 | 1701 | 1705 | | Assemble frame |
| 1701 | 1705 | 1805 | | |
| | 1800 | | Quality | |
| | | | Assurance | |
| | | | (QA) | |
| 1601 | 1801 | 1901 | | Finished goods (FG) |
| | | | | panel |
| 1705 | 1805 | 1905 | | FG frame |
| | 1900 | | Packing | |
| | 1901 | | | FG panel |
| | 1905 | | | FG frame |

Many of the modules, sub-modules, processes, and sub-processes are similar to those addressed above with respect to Table 1 and FIG. 9. Most of the differences relate to the assembly of the clinched security screen panel. Also, as can be seen in FIG. 11, an order of various steps of the modules and sub-modules is identified. Other differences are addressed generally below.

Module 1100 still addresses extrusion cutting, but as can be seen, sub-module 1101 addresses inner sash cutting. This is in contrast to module 1101 in Table 1 and FIG. 9, which involved wedge cutting. In one aspect, the inner sash has replaced the wedge addressed above.

A primary difference in FIG. 11 is the replacement of module 1500 (from Table 1 and FIG. 9) with modules 1300 and 1400. In one form, as addressed below, the flow in FIG. 11 proceeds to process (or module) 1300, which is pre-assembly of a clinched security screen panel, and process (or module) 1400, which is panel assembly of the clinched security screen panel, such as panel assemblies shown in FIGS. 7A, 7B, 7C, and 7D. The flow skips process 1500, which is specific to the wedged security screen system.

At module 1300, in one form, pre-assembly of the clinched panel is performed. At sub-module 1301, the insulator is attached to the mesh sheet. In one form, the cut-to-size mesh sheet may be arranged on a trolley/cart and parked at a designated area, and then a robotic device, such as a robotic arm, picks up the mesh sheet and places it on an assembly table. The robotic device may also pick up the cut-to-size insulators and attach them onto the mesh sheet on all four sides of the mesh sheet.

At sub-module 1305, in one form, the inner sash is attached to the mesh sheet. In one form, a cart with inner sashes will stop at the designated area, and a robotic device picks up four inner sashes for four sides of the mesh sheet and places them on a crimping fixture. A crimping machine may clamp the inner sashes to fit snugly against the insulators along the sides of the mesh sheet. Once the crimping is complete, the crimping machine opens, and the robotic device may pick up the workpiece and move it to a transferring device, such as a conveyor.

At sub-module 1310, in one form, clinching is performed. The mesh sheet with the insulators and inner sash may be automatically transferred to a designated position. In one form, a robotic device may use clinching equipment to perform a clinching process along the length of the inner sash. Generally, clinching is a conventional joining process involving deformation and compressing of sheet materials. After the clinching is completed, the robotic device returns to its starting point to be ready for the next panel. The workpiece is transferred to the next position/station.

At sub-module 1315, in one form, self-piercing riveting is performed to apply a rivet or other fastener to the combination mesh sheet, insulator, and inner sash. The mesh sheet with insulators and inner sashes may be automatically transferred from the previous sub-module to a designated position. In one form, a robotic device may operate self-piercing rivet equipment to apply rivets or other fasteners along the length of the inner sash. After the self-piercing riveting is completed, the robotic device returns to its starting point to be ready for the next panel. The workpiece is transferred to the next position/station.

In one form, the flow then proceeds to module 1400, which involves assembly of the panel. At sub-module 1401, the mesh sheet with insulators and inner sashes is automatically transferred from the previous sub-module to a designated position. An individual may insert a corner stake in an outer sash and then place it into the cart and park the cart at the designated area. A robotic device may pick up the outer sashes for the sides of the panel and may mount them on a positioning fixture, and then, elements of the positioning fixture press inwardly toward the center of the mesh sheet to attach the outer sashes to the mesh sheet. The panel is transferred to the next position/station.

At sub-module 1405, in one form, the panel is centered. After that, crimping heads of a crimping machine may move to the four corners of the panel. The machine may crimp the corners tightly and control a corner gap within a specified value. After the four corners are crimped, the machine releases the panel. The panel is automatically transferred to the next position.

At sub-module 1410, in one form, assembly of the clinched panel is completed. When the panel moves to this specified position, automatic clamp sets hold the panel in place. The Insulators and inner sashes along the height side (generally the right and left sides) are in place. At sub-module/sub-process 1415, in one form, a pulling automation head may press the insulators and inner sashes of the width side against the outer sashes along the width sides of the panel, thereby securing and tightening the insulators and inner sashes to the outer sashes. The panel is then transferred to the next station

As stated above, the other modules and sub-modules in FIG. 11 and Table 2 are generally similar to FIG. 9 and Table 1. In other words, the other processes and sub-processes in the clinched system are generally similar to the other processes and sub-processes in the wedged system. The above description of the other processes and sub-processes are incorporated herein.

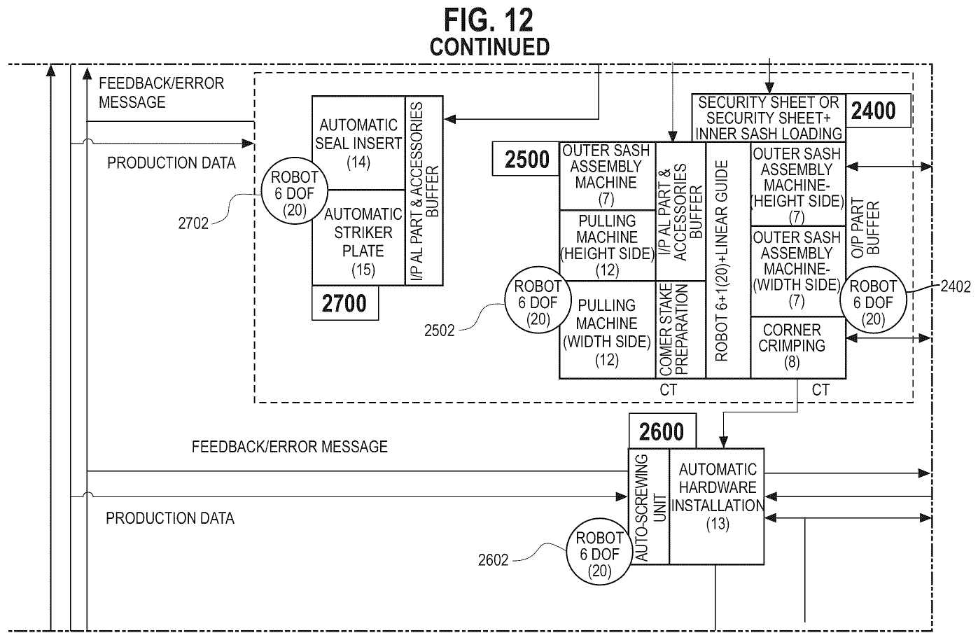

FIG. 12 shows a schematic diagram showing an example of the production flow/line for manufacturing a screen security system. FIG. 12 has been broken out into five separate sheets of figures. The first sheet shows the general overall layout of the production flow/line and is separated by broken lines into four separate portions, which are shown in the following sheets of figures. The second sheet shows the upper left portion of the layout, the third sheet shows the upper right portion of the layout, the fourth sheet shows the middle left portion of the layout, and the fifth sheet shows the bottom portion of the layout.

At block 2010, in one form, there is an ERP system material control for the materials for the screen security system. The materials may generally include aluminum, such as for outer sashes and the inner sashes; rubber, such as for insulators; and stainless steel wire or other material for mesh. At block 2020, in one form, there is a master computer with production software that may control, communicate, and receive feedback from the various production stations. It may also communicate with an ERP system 2030, such as, for example, to receive detailed information regarding the characteristics of individual orders. In addition, as can be seen, materials and components may be transferred between blocks/stations by conveyor or trolley cart, and data and feedback may be communicated between blocks/stations.

In one form, the blocks/stations 2100-2900 generally correspond to the modules 1100-1900 described above, which description is incorporated herein. At blocks 2100 and 2200, in one form, extrusion cutting and extrusion routing are performed, and appropriate material may be requested from ERP system material control. It is generally contemplated that various components of the security screen system are cut to predetermined sizes and shapes. For example, the outer sashes, inner sashes, wedges, frames, and corner stakes may be cut to desired sizes and shapes. Further, it is generally contemplated that extrusion routing is performed on certain components, such as, for example, the outer sashes and frames. Routing is performed so as to create recesses and hollows in these components, such as, for example, to allow latches and handles to be inserted or mounted therein. At block 2100, aluminum and rubber cutting process may be performed, while at block 2200, routing and milling may be performed.

In one form, this cutting and routing may be automated using computer numerical control (CNC) for cutting and machining. This CNC approach allows computer control of movement, cutting, and routing of the various components so as to allow them to be machined in a precise and consistent manner. As shown in FIG. 12, it is generally contemplated CNC cutting centers 2102 and CNC machines 2202 perform CNC cutting and routing at cutting station 2100 and routing station 2200, respectively.

Further, cutting and routing may be facilitated through the use of robotic devices, conveyor feeding, QR code tracking, etc. In one form, it is generally contemplated that robots 2104, 2106, 2302, 2304, 2306, 2402, 2502 2602, 2702, preferably in the form of robotic arms, are used at the various stations 2100, 2200, 2300, 2400, 2500, 2600, and 2700 to handle and/or machine the panels, the frames, and the various panel and frame components. In addition, in one form, automated guided vehicles (AGVs) may be used to transfer materials. Also, linear guides may be used in the production flow to ensure smooth and precise linear movement along a single axis in automated assembly lines, such as, for example, to move parts or tools along conveyor belts or within machinery.

At block 2300, in one form, preassembly, or partial assembly, of a security screen panel is performed. This block/station may be optional and may be used or preassembly of certain types of security screen panels, such as, for example, clinched security screen panels. Mesh may be transferred from the ERP system material control and may be cut by a laser machine (or other suitable cutting machine). Further, various components (which have been cut and/or routed at blocks 2100 and 2200) may be transferred over to block/station 2300. At block 2300, mesh may be loaded. It is generally contemplated that there may be trolleys/areas for materials and products, such as an input of aluminum and accessories in one area and an output of parts or products.

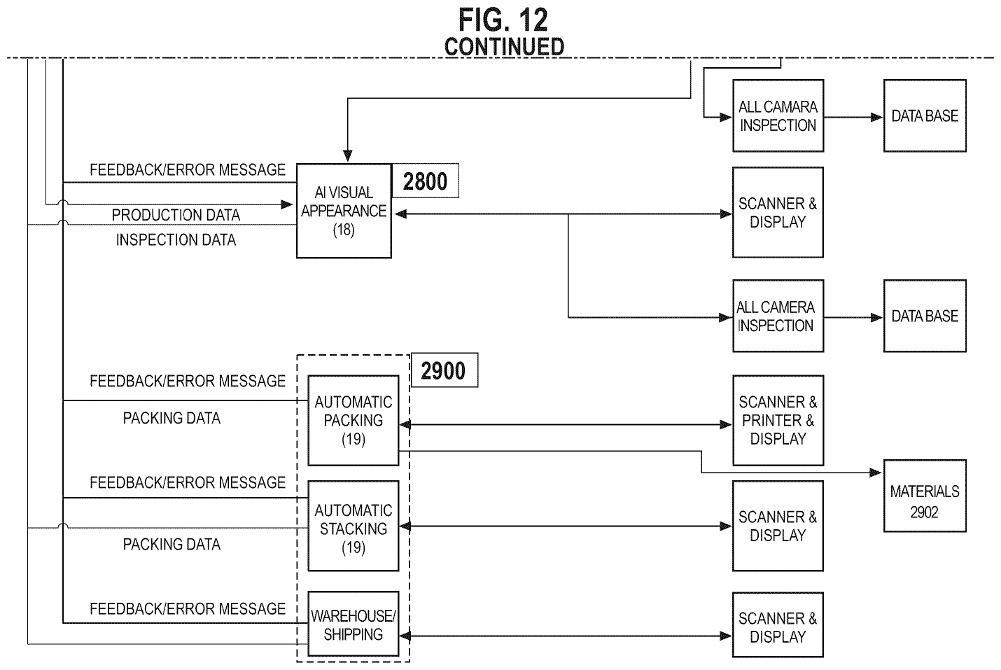

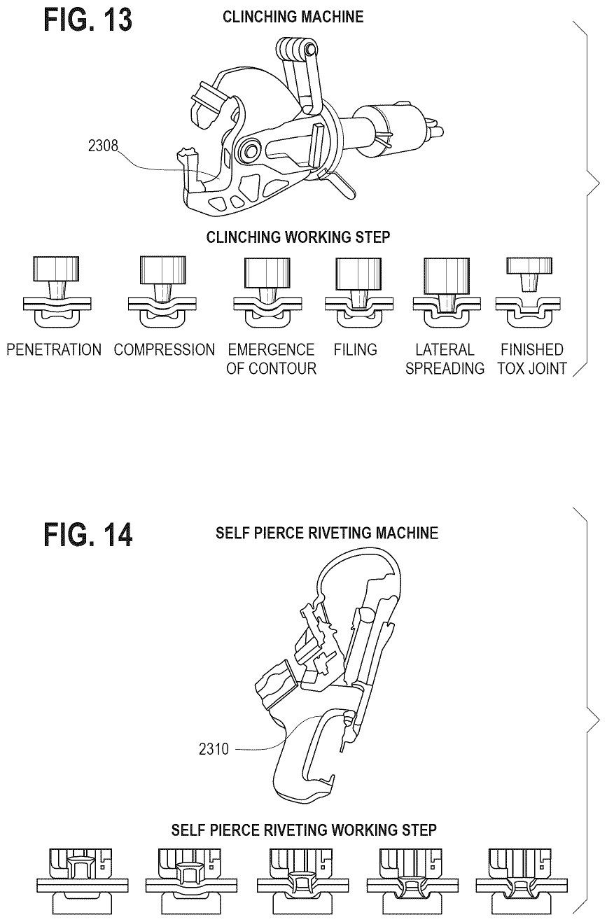

In one form, the preassembly may involve an insulator and inner sash of different lengths depending on the door and window sizes. The mesh, insulator, and inner sash may be clinched together using clinching equipment, and a fastener may be inserted using a self-piercing rivet (SPR) tool. FIG. 13 shows an example of a clinching machine or clinching equipment 2308 that may be attached to and operated by a robot 2304, such as a robotic arm. FIG. 14 shows an example of an SPR tool 2310 that may be attached to and operated by another robot 2306, such as another robotic arm.

It is further contemplated that AI camera inspection may be performed and compared against a database for quality control. AI camara inspection may be used to automatically analyze and inspect objects or products using high-resolution cameras to capture images of the items being inspected and using image processing software. A main purpose of these systems is to ensure quality control and verify that items meet specified criteria. In one form, tasks for this process may involve detecting the positions of clinch and self-piercing rivets and measuring the dimensions of screens by using data, such as, for example, labeled images and associated metadata from databases for decision making and feedback for machine learning.

At blocks 2400 and 2500, in one form, assembly of the security screen panel is performed. This block/station may use components that have been preassembled at block 2300 or may use components without the preassembly step for certain types of security screen panels. For example, block 2400 may be directed to assembly of clinched systems (and may receive the preassembled components from block 2300), and block 2500 may be directed to assembly of wedge systems. The outer sashes may be machined on the height side (long side) and/or the width side (short side) of the security screen panel. Outer sash assembly (height side) generally refers to attaching an outer sash at the height of the panel, i.e., typically on the right and left sides of the panel, and outer sash assembly (width side) generally refers to attaching an outer sash at the width of the panel, i.e., typically on the top and bottom of the panel.

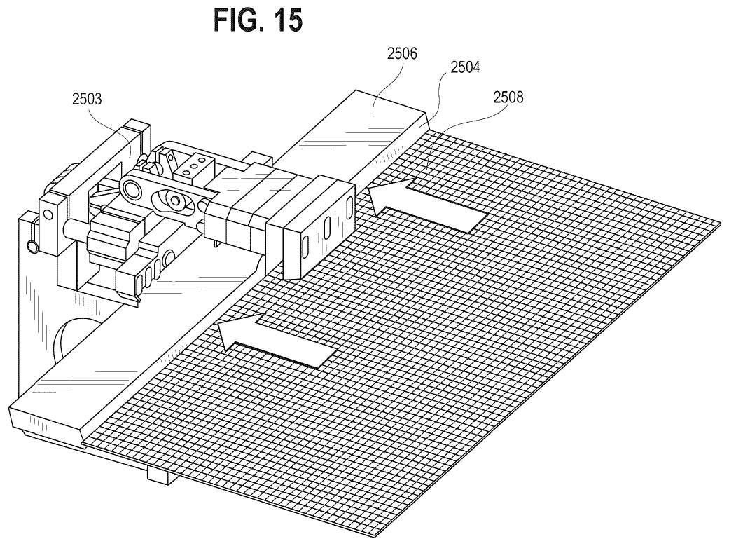

At block 2500, in one form, a pulling machine may be used to pull an outer sash towards the center of a security screen panel and over an inner sash/wedge engaging mesh. FIG. 15 shows an example of a pulling machine 2503 that may be used to insert wedges 2504 into outer sashes 2506 of the security screen panel by pulling/inserting wedges into gaps between the outer sash and mesh sheet 2508 along the inner perimeter of the panel. In addition, the corner stake(s) may be prepared, and the corners of the panel may be crimped to assure that the outer sashes of the panel are securely fastened to one another.

In one form, it is contemplated that AI camera inspection may be performed and compared against a database for quality control. In one form, AI camara inspection may be used to automatically analyze and inspect objects or products using high-resolution cameras to capture images of the items being inspected and using image processing software. A main purpose of these systems is to ensure quality control and to verify that items meet specified criteria. In one form, tasks for this process may include inspecting the quality of corner joints and inspecting the quantity of screws by using data, such as, for example, labeled images and associated metadata from databases for decision making and feedback for machine learning.

At block 2600, in one form, hardware may be installed in the security screen panel, preferably using an auto-screwing unit. For example, latches and handles may be installed in the security screen panels, such as, for example, in hollows and recesses that have been routed in the panels. It is generally contemplated that hardware may be obtained from hardware block/station. Various forms of latches and locks may be installed, such as, for example, single bar multi point, single-point, espagnolette bolt, and driver gear latches and/or locks.

In one form, at this stage, it is contemplated that AI camera inspection may be performed and compared against a database for quality control. As previously stated, in one form, AI camara inspection may be used to automatically analyze and inspect objects or products using high-resolution cameras capture images of the items being inspected and using image processing software. A main purpose of these systems is to ensure quality control and verify that items meet specified criteria. In one form, tasks for this process may include inspecting the position of the hardware setup and the quantity of screws by using data, such as, for example, labeled images and associated metadata from databases for decision making and feedback for machine learning.

At block 2700, in one form, frame portions may be assembled to form the frame and other components may be added. For example, seals and striker plates may be installed on the frame, which may facilitate installation of the security screen panel in a building. It is contemplated that the security screen frame was the subject of extrusion cutting and/or routing at blocks 2100 and 2200 so as to enable installation of the frame components on the frame. Frame assemblies with corner screws (or stakes) are used at each of the corners of the frame to fasten one frame assembly to another.

At block 2800, in one form, assembly of the security screen panel and the security screen frame have been completed. At block 2800, an AI visual appearance inspection is performed on the assembled panel and on the assembled frame. Then, at block 2900, the assembled panel and assembled frame may be packed, stacked with others, and stored at a warehouse and/or shipped to the orderer or to another designated location. This packing and arrangement may include the following features: packing may utilize the transfer doors and windows through various stages of the packing process by a conveyor system; pick-and-place systems may handle the doors or windows at packaging stations and perform tasks such as stacking or sorting; packing by shrink wrapping may use plastic film that shrinks tightly around a door when heated and next with wraparound packaging by using cardboard to form a protective box around the door; packing automated systems may adjust to different door sizes and shapes through the application and reading of labels, barcodes, or QR codes for identification and tracking; inspection and quality control by vision systems and sensors may check for proper packaging, labeling accuracy; and stacking and palletizing systems may arrange packaged doors onto pallets or in stacking configurations for shipment or storage in a warehouse. FIG. 12 shows shrink wrap and packaging materials 2902 that may be used in this packing process. In one form, these features may be integrated with software and control systems to manage and coordinate the various components of the automated packing process.

In one form, there is provided in this disclosure a security screen manufacturing system. The security screen manufacturing system includes: a material control station holding materials to be machined and assembled into security screen systems, each security screen system including: an infill sheet with four sides; a plurality of panel assemblies surrounding and engaging the infill sheet to form a panel with the infill sheet; at least one of the panel assemblies including: an outer sash comprising two sidewalls defining a channel therebetween, each sidewall including at least one engagement portion; and an inner member received in the channel of the outer sash, the inner member comprising two legs, each leg engaging a sidewall and each leg including at least one corresponding engagement portion for engagement with the least one engagement portion of a sidewall to facilitate retention of the inner member within the channel, the inner member receiving a portion of the infill sheet within a groove formed by the two legs. The security screen manufacturing system also includes: a cutting station receiving materials from the material control station, the cutting station using computer numerical control (CNC) cutting to cut materials to form the outer sash and the inner member to a predetermined size and shape; a routing station receiving the cut outer sash from the cutting station and a profile identifying a routing style of the outer sash, the routing station using a CNC machine to form one or more recesses in the outer sash according to the routing style; and at least one panel assembly station receiving and assembling the infill sheet, outer sash, and inner member to form the panel.

In some implementations, in the system, materials at the material control station comprise aluminum for outer sashes and inner members, rubber for insulators, and/or stainless steel wire for infill sheets. In some implementations, the system further includes a panel pre-assembly station wherein: a first robot at the panel pre-assembly station picks up and places an infill sheet on a positioning fixture; the first robot attaches an insulator to each of the four sides of the infill sheet; the inner member, comprising an inner sash, is crimped to the insulator along the four sides of the infill sheet; the inner member, insulator, and infill sheet are clinched to join them together; and a fastener is applied through the joined combination of inner member, insulator, and infill sheet. In some implementations, a second robot at the panel pre-assembly station operates clinching equipment to clinch the inner sash, insulator, and infill sheet to join them together; and/or a third robot at the panel pre-assembly station operates self-piercing riveting equipment to apply the fastener through the joined combination of inner member, insulator, and infill sheet. In some implementations, the at least one panel assembly station comprises a first panel assembly station wherein: the infill sheet with inner sash and insulator is received from the pre-assembly station and mounted on a positioning fixture; a first robot at the first panel assembly station picks up and places four outer sashes on the positioning fixture outside a perimeter defined by the four sides of the infill sheet; and the four outer sashes are pressed toward the four sides of the infill sheet to attach the joined combination of inner sash, insulator, and infill sheet to form an assembled panel. In some implementations, a plurality of holes are drilled through each inner sash and each outer sash; a plurality of fasteners are applied to the drilled holes to secure each inner sash to an outer sash; and a second robot at the first panel assembly station picks up cover sashes and uses pressing equipment to apply each cover sash to a corresponding outer sash to cover fastener in the corresponding outer sash.

In some implementations, in the system, the at least one panel assembly station includes a second panel assembly station wherein: adhesive tape is applied to the inner member comprising a wedge; the wedge is inserted into the channel of the outer sash; the infill sheet is picked up and placed on a positioning fixture; four outer sashes with inserted wedges are picked up and placed on the positioning fixture outside a perimeter defined by the four sides of the infill sheet; and the four outer sashes are pressed into engagement with the four sides of the infill sheet. In some implementations, a robot at the second panel assembly station picks up and places the infill sheet and the four outer sashes on the positioning fixture. In some implementations, the system further includes a hardware assembly station, wherein a robot at the hardware assembly station applies a hardware lock or latch to a recess formed in the panel to receive the hardware lock or latch, the recess being formed at the routing station. In some implementations, the system further includes a frame assembly station, wherein: a seal is inserted into a groove of a frame portion along its length; at least three frame portions are mounted on a positioning fixture with at least two corner stakes in two of the frame portions; the at least three frame portions with seals are pressed into engagement with one another such that two adjacent frame portions are fastened to each other to form the frame; and a robot at the frame assembly station with riveting equipment fastens at least one striker plate to the frame. In some implementations, the system further includes a quality assurance station, wherein: a camera system captures images of assembled panels and uses image processing to perform at least one of: detecting and identifying damage to the assembled panels; measuring dimensions and confirming they fall within predetermined ranges; and ensuring that parts of the assembled panels have been assembled in accordance with a predetermined design for a panel type. In some implementations, the system further includes a packing station, wherein: shrink wrapping in the form of plastic film is heated to shrink around an assembled panel; and wraparound packaging is applied to form a protective box around the assembled panel.

In another form, there is provided a method of manufacturing security screen systems. The method includes: at a material control station, holding materials to be machined and assembled into security screen systems, each security screen system including: an infill sheet with four sides; a plurality of panel assemblies surrounding and engaging the infill sheet to form a panel with the infill sheet; at least one of the panel assemblies including: an outer sash comprising two sidewalls defining a channel therebetween, each sidewall including at least one engagement portion; and an inner member received in the channel of the outer sash, the inner member comprising two legs, each leg engaging a sidewall and each leg including at least one corresponding engagement portion for engagement with the least one engagement portion of a sidewall to facilitate retention of the inner member within the channel, the inner member receiving a portion of the infill sheet within a groove formed by the two legs. The method further includes: at a cutting station, receiving materials from the material control station and using computer numerical control (CNC) cutting to cut materials to form the outer sash and the inner member to a predetermined size and shape; at a routing station, receiving the cut outer sash from the cutting station and a profile identifying a routing style of the outer sash and using a CNC machine to form one or more recesses in the outer sash according to the routing style; and at one or more panel assembly stations, receiving and assembling the infill sheet, outer sash, and inner member to form the panel. Additionally, implementations of the method may include, without limitation, one or more of the implementations addressed above with respect to the security screen manufacturing system.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the technological contribution. The actual scope of the protection sought is intended to be defined in the following claims.

1. A security screen manufacturing system comprising:
a material control station holding materials to be machined and assembled into security screen systems, each security screen system comprising:
an infill sheet with four sides;
a plurality of panel assemblies surrounding and engaging the infill sheet to form a panel with the infill sheet;
at least one of the panel assemblies comprising:
an outer sash comprising two sidewalls defining a channel therebetween, each sidewall including at least one engagement portion;
an inner member received in the channel of the outer sash, the inner member comprising two legs, each leg engaging a sidewall and each leg including at least one corresponding engagement portion for engagement with the at least one engagement portion of a sidewall to facilitate retention of the inner member within the channel, the inner member receiving a portion of the infill sheet within a groove formed by the two legs;
a cutting station receiving materials from the material control station, the cutting station using computer numerical control (CNC) cutting to cut materials to form the outer sash and the inner member to a predetermined size and shape;
a routing station receiving the outer sash from the cutting station and a profile identifying a routing style of the outer sash, the routing station using a CNC machine to form one or more recesses in the outer sash according to the routing style; and
at least one panel assembly station receiving and assembling the infill sheet, outer sash, and inner member to form the panel.

2. The security screen manufacturing system of claim 1, wherein materials at the material control station comprise aluminum for outer sashes and inner members, rubber for insulators, and/or stainless steel wire for infill sheets.

3. The security screen manufacturing system of claim 1, further comprising a panel pre-assembly station wherein:
a first robot at the panel pre-assembly station picks up and places an infill sheet on a positioning fixture;
the first robot attaches an insulator to each of the four sides of the infill sheet;
the inner member, comprising an inner sash, is crimped to the insulator along the four sides of the infill sheet;
the inner member, insulator, and infill sheet are clinched to join them together; and
a fastener is applied through the joined combination of inner member, insulator, and infill sheet.

4. The security screen manufacturing system of claim 3, wherein:
a second robot at the panel pre-assembly station operates clinching equipment to clinch the inner sash, insulator, and infill sheet to join them together; and/or
a third robot at the panel pre-assembly station operates self-piercing riveting equipment to apply the fastener through the joined combination of inner member, insulator, and infill sheet.

5. The security screen manufacturing system of claim 3, wherein the at least one panel assembly station comprises a first panel assembly station wherein:
the infill sheet with inner sash and insulator is received from the pre-assembly station and mounted on a positioning fixture;
a first robot at the first panel assembly station picks up and places four outer sashes on the positioning fixture outside a perimeter defined by the four sides of the infill sheet; and
the four outer sashes are pressed toward the four sides of the infill sheet to attach the joined combination of inner sash, insulator, and infill sheet to form an assembled panel.

6. The security screen manufacturing system of claim 1, wherein the at least one panel assembly station comprises a second panel assembly station wherein:
adhesive tape is applied to the inner member comprising a wedge;
the wedge is inserted into the channel of the outer sash;
the infill sheet is picked up and placed on a positioning fixture;
four outer sashes with inserted wedges are picked up and placed on the positioning fixture outside a perimeter defined by the four sides of the infill sheet; and
the four outer sashes are pressed into engagement with the four sides of the infill sheet.

7. The security screen manufacturing system of claim 6, wherein:
a robot at the second panel assembly station picks up and places the infill sheet and the four outer sashes on the positioning fixture.

8. The security screen manufacturing system of claim 1 further comprising a hardware assembly station, wherein a robot at the hardware assembly station applies a hardware lock or latch to a recess formed in the panel to receive the hardware lock or latch, the recess being formed at the routing station.

9. The security screen manufacturing system of claim 1 further comprising a frame assembly station, wherein:
a seal is inserted into a groove of a frame portion along its length;
at least three frame portions are mounted on a positioning fixture with at least two corner stakes in two of the frame portions;
the at least three frame portions with seals are pressed into engagement with one another such that two adjacent frame portions are fastened to each other to form a frame; and
a robot at the frame assembly station with riveting equipment fastens at least one striker plate to the frame.

10. The security screen manufacturing system of claim 1 further comprising a quality assurance station, wherein:
a camera system captures images of assembled panels and uses image processing to perform at least one of: detecting and identifying damage to the assembled panels; measuring dimensions and confirming they fall within predetermined ranges; and ensuring that parts of the assembled panels have been assembled in accordance with a predetermined design for a panel type.

11. The security screen manufacturing system of claim 1 further comprising a packing station, wherein:
shrink wrap in the form of plastic film is heated to shrink around an assembled panel; and
wraparound packaging is applied to form a protective box around the assembled panel.

12. A method of manufacturing security screen systems comprising:
at a material control station, holding materials to be machined and assembled into security screen systems, each security screen system comprising:
an infill sheet with four sides;
a plurality of panel assemblies surrounding and engaging the infill sheet to form a panel with the infill sheet;
at least one of the panel assemblies comprising:
an outer sash comprising two sidewalls defining a channel therebetween, each sidewall including at least one engagement portion;
an inner member received in the channel of the outer sash, the inner member comprising two legs, each leg engaging a sidewall and each leg including at least one corresponding engagement portion for engagement with the least one engagement portion of a sidewall to facilitate retention of the inner member within the channel, the inner member receiving a portion of the infill sheet within a groove formed by the two legs;
at a cutting station, receiving materials from the material control station and using computer numerical control (CNC) cutting to cut materials to form the outer sash and the inner member to a predetermined size and shape;
at a routing station, receiving the outer sash from the cutting station and a profile identifying a routing style of the outer sash and using a CNC machine to form one or more recesses in the outer sash according to the routing style; and
at one or more panel assembly stations, receiving and assembling the infill sheet, outer sash, and inner member to form the panel.

13. The method of manufacturing security screen systems of claim 12, further comprising, at a panel pre-assembly station:
by a first robot at the panel pre-assembly station, picking up and placing an infill sheet on a positioning fixture;
by the first robot, attaching an insulator to each of the four sides of the infill sheet;
crimping the inner member, comprising an inner sash, to the insulator along the four sides of the infill sheet;
clinching the inner member, insulator, and infill sheet to join them together; and
applying a fastener through the joined combination of inner member, insulator, and infill sheet.

14. The method of manufacturing security screen systems of claim 13, further comprising, at the panel pre-assembly station:
by a second robot at the panel pre-assembly station, operating clinching equipment to clinch the inner sash, insulator, and infill sheet to join them together; and/or
by a third robot at the panel pre-assembly station, operating self-piercing riveting equipment to apply the fastener through the joined combination of inner member, insulator, and infill sheet.

15. The method of manufacturing security screen systems of claim 14, wherein the one or more panel assembly stations comprise a first panel assembly station, the method further comprising, at the first panel assembly station:
receiving the infill sheet with inner sash and insulator from the pre-assembly station and mounting it on a positioning fixture;
by a first robot at the first panel assembly station, picking up and placing four outer sashes on the positioning fixture outside a perimeter defined by the four sides of the infill sheet; and
pressing the four outer sashes toward the four sides of the infill sheet to attach the joined combination of inner sash, insulator, and infill sheet to form an assembled panel.

16. The method of manufacturing security screen systems of claim 12, wherein the one or more panel assembly stations comprises a second panel assembly station, the method further comprising, at the second panel assembly station:
applying adhesive tape to the inner member comprising a wedge;
inserting the wedge into the channel of the outer sash;
by a robot at the second panel assembly station, picking up and placing the infill sheet on a positioning fixture;
by the robot at the second panel assembly station, picking and placing four outer sashes with inserted wedges on the positioning fixture outside a perimeter defined by the four sides of the infill sheet; and
pressing the four outer sashes into engagement with the four sides of the infill sheet.

17. The method of manufacturing security screen systems of claim 12, further comprising, at a hardware assembly station:
by a robot at the hardware assembly station, applying a hardware lock or latch to a recess formed in the panel to receive the hardware lock or latch, the recess being formed at the routing station.

18. The method of manufacturing security screen systems of claim 12, further comprising, at a frame assembly station:
inserting a seal into a groove of a frame portion along its length;
mounting at least three frame portions on a positioning fixture with at least two corner stakes in two of the frame portions;
pressing the at least three frame portions with seals into engagement with one another such that two adjacent frame portions are fastened to each other to form the frame; and
by a robot at the frame assembly station with riveting equipment, fastening at least one striker plate to the frame.

19. The method of manufacturing security screen systems of claim 12 further comprising, at a quality assurance station:
by a camera system, capturing images of assembled panels and using image processing to perform at least one of: detecting and identifying damage to the assembled panels; measuring dimensions and confirming they fall within predetermined ranges; and ensuring that parts of the assembled panels have been assembled in accordance with a predetermined design for a panel type.

20. The method of manufacturing security screen systems of claim 12 further comprising, at a packing station:
heating shrink wrap in the form of plastic film to shrink around an assembled panel; and
applying wraparound packaging to form a protective box around the assembled panel.
